(19) United States
(12) Patent Application Publication
(10) Pub. No.: US 2026/0058461 A1
(43) Pub. Date: Feb. 26, 2026

(54) SUBSTATION WITH POWER VOLTAGE TRANSFORMER CONNECTED THROUGH CIRCUIT DEVICE TO HIGH OR EXTRA HIGH VOLTAGE TRANSMISSION LINE

(71) Applicant: Siemens Energy Global GmbH & Co. KG, München (DE)

(72) Inventor: Tiago Santos Guimaraes, Erlangen (DE)

(21) Appl. No.: 18/997,608

(22) PCT Filed: Jul. 29, 2022
(86) PCT No.: PCT/US2022/038790

§ 371 Date: Jan. 22, 2025

(51) Int. Cl. H02H 7/26; H02G 7/00

(52) U.S. Cl. CPC H02H 7/261; H02G 7/00

(57) ABSTRACT

A substation connected to a high or extra-high voltage transmission line is disclosed. The substation includes a power line electrically connected to the transmission line. A circuit device is electrically connected by way of the line to receive the high or the extra-high voltage from the transmission line. The circuit device is responsive to a faulty condition that can arise during operation of the substation. A power voltage transformer is electrically connected to the circuit device to supply low voltage power directly transformed from the high or the extra high voltage received by the power voltage transformer from the circuit device. Example applications that can benefit from disclosed embodiments include applications for establishing a low voltage electrical power distribution in a rural or semi-rural area, such as may be used to power electric vehicle charging stations, sites involving telecommunication equipment (e.g., arrays of 5G antennas), or effective for village electrification.

### BACKGROUND

Disclosed embodiments relate generally to the field of electric power generation and distribution, and, more particularly, to an electrical substation with a power voltage transformer connected through a circuit device to, for example, a high voltage (HV) or extra high voltage (XHV) transmission line to supply electrical power transformed by the power voltage transformer for low voltage applications.

Availability of substations that, for example, may be used for establishing cost-effective and reliable low voltage electrical power distribution in certain remote locations, such as may involve rural or semi-rural locations, has been challenging.

European patent EP3616294 discloses an electric vehicle charging station for connecting to a span of a transmission line. As can be appreciated in FIG. 6 of the instant application, (based on FIG. 4 of said patent) the foregoing charging station is connected by way of a charging station tap (CST) to a span of the transmission line featuring an electrical insulation string located between points A and B. A substation (CSS) is fed from the charging station tap (CST) and the substation (CSS) involves one or more power voltage transformers (PT1) for transforming the high or extra high voltage to a low voltage for feeding one or more electric vehicle chargers (CSP). This patent expressly discloses that each respective power voltage transformer is arranged to supply low voltage power directly from the transmission line. The charging station tap (CST) is connected to the electric vehicle charging station through a line disconnect switch (LDS) that is used during maintenance or servicing events to electrically disconnect the station from the transmission line. As will be appreciated by one skilled in the art, and reiterated in said patent, a line disconnect switch (LDS) lacks an electrical arc suppression mechanism or similar mechanism that may be responsive to electrical faulty conditions to interrupt or inhibit an excessive flow of current that can develop during such conditions. The line disconnect switch (LDS) is intended to be used only after the power network or transmission line has been appropriately de-energized.

### SUMMARY

In one aspect, a substation connected to a high or extra-high voltage transmission line is disclosed. The substation includes a power line having a first end electrically connected to a singular point of the transmission line. A circuit device is electrically connected to a second end of the power line to receive the high or the extra-high voltage from the transmission line. The circuit device is responsive to a faulty condition that can arise during operation of the substation. A power voltage transformer is electrically connected to the circuit device. The power voltage transformer is configured to supply low voltage power directly transformed from the high or the extra high voltage received by the power voltage transformer from the circuit device.

In one aspect, the circuit device is configured to inhibit effects of the faulty condition. The circuit device may be configured in any one of various modalities, such as a circuit breaker or a fuse configured to interrupt a flow of current indicative of the faulty condition. In another modality, the circuit device may be configured to limit a flow of current indicative of the faulty condition, such as may be implemented by way of a current limiting reactor, or by way of a current limiting resistive device.

The foregoing has broadly outlined some of the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 is a schematic of one embodiment of a disclosed electrical substation including a circuit device electrically connected to a high or extra-high voltage transmission line, where the circuit device is responsive to a faulty condition that can arise during operation of the substation.

FIG. 2 is a schematic of a further embodiment of a disclosed substation, where the circuit device is a circuit breaker.

FIG. 3 is a schematic of another embodiment of a disclosed substation, where the circuit device is a current limiting reactor.

FIG. 4 is a schematic of still another embodiment of a disclosed substation, where the circuit device is a current limiting resistive device.

FIG. 5 is a schematic of yet another embodiment of a disclosed substation, where the circuit device is a fuse.

FIG. 6 is a schematic representation of a prior art electrical layout according to a representative embodiment of a charging station tap, as disclosed EP3616294.

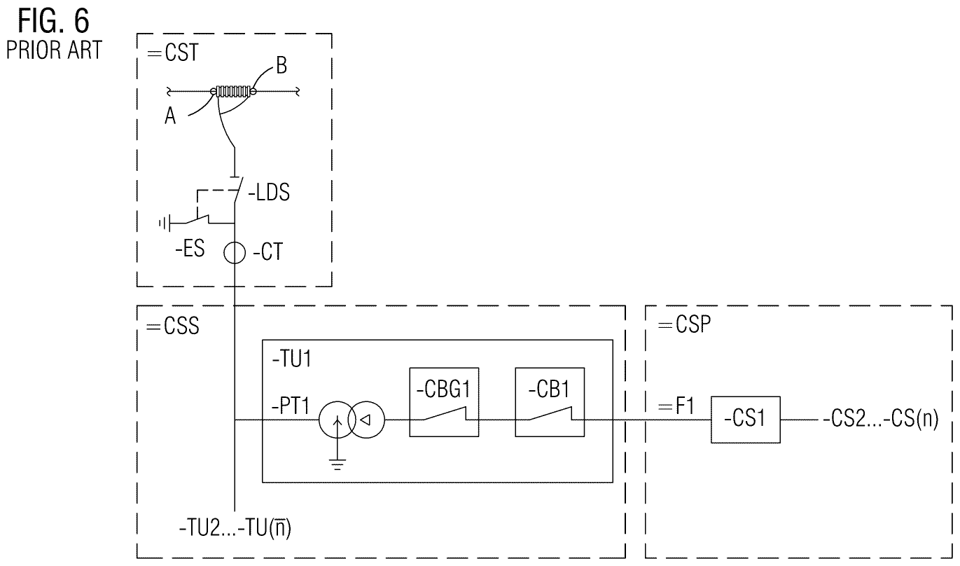

### DETAILED DESCRIPTION

The present inventor has recognized that an electrical substation which is connected to a high voltage (HV) or extra high voltage (XHV) transmission line merely through a line disconnect switch (LDS), such as lacking an electrical arc suppression mechanism, can present undesirable issues in the presence of electrical faulty conditions that can arise during operation of the substation. EP3616294 is one example of a substation which is connected to a high voltage (HV) or extra high voltage (XHV) transmission line by way of a line disconnect switch (LDS). The line disconnect switch (LDS) is not designed to be responsive to electrical faulty conditions and therefore line disconnect switch (LDS) is not meant to interrupt or inhibit an excessive flow of current that can develop during such conditions.

Before any disclosed embodiments are explained in detail, it is to be understood that each disclosed embodiment is not limited in its application to the details of construction and the arrangement of components set forth in this description or illustrated in the following drawings. Each disclosed embodiment may be realized by other embodiments and of being practiced or of being carried out in various ways. Also, it is to be understood that the phraseology and terminology used herein is for the purpose of description and should not be regarded as limiting.

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

It should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean that an element is relatively near to but not in contact with a further element or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard is available, a variation of twenty percent would fall within the meaning of these terms unless otherwise stated.

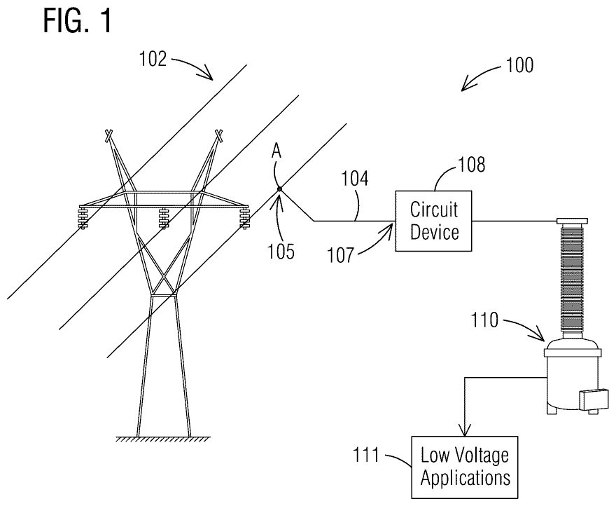

FIG. 1 is a schematic of one embodiment of a disclosed electrical substation 100. As shown in FIG. 1, substation 100 is connected to a high voltage or extra-high voltage transmission line 102, such may range from 60 kV to 800 kV and, more particularly, such as may range from 72.5 kV to 400 kV. Substation 100 includes a power line 104 having a first end 105 electrically connected to a singular point (A) of the transmission line. A circuit device 108 is electrically connected to a second end 107 of power line 104 to receive the high or the extra-high voltage from transmission line 102. Circuit device 108 is responsive to electrical faulty conditions that can arise during operation of the substation. Examples of electrical faulty conditions, without limitation, may involve electrical shorts, electrical overloads, etc., where an excessive flow of current can quickly develop. In any case, regardless of the specific electrical faulty condition, it is desirable to avoid the effects of any such faulty condition over a relatively short period of time. That is, it is desirable to quickly and reliably interrupting or inhibiting any excessive flow of current that otherwise could result in substantial damage to equipment and/or could be harmful to personnel and avoid the possibility of any extended interruption of power to customers.

A power voltage transformer 110 is electrically connected to circuit device 108. Power voltage transformer 110 is configured to supply low voltage power (such as below 1 kV) directly transformed from the high or the extra high voltage received by power voltage transformer 110 from circuit device 106. The high voltage side of power voltage transformer may be rated from 60 kV to 800 kV and, more particularly, from 72.5 kV to 550 kV. The transformation of the high or the extra high voltage to the low power voltage is carried out without medium voltage circuitry. That is, without involving a medium voltage stage, such as may range from 1 kV to 60 kV.

The low voltage power from power transformer 110 may be used to power a variety of low voltage applications, schematically represented by block 111.

Non-limiting example applications that may benefit from disclosed embodiments may include applications for establishing a low voltage electrical power distribution in a rural or semi-rural area, such as may be used to power one or more of the following: village electrification, electric vehicle charging stations, sites involving telecommunication equipment (e.g., arrays of 5G antennas), illumination towers, water (or other fluids) pumping stations, mining sites, defense applications, health care facilities and/or hospitals, railroad electrical equipment, etc. For simplicity of illustration and explanation and not by way of limitation, FIG. 1 focuses on an example electrical connection to just one of the lines of the transmission line.

It is estimated that in the order of approximately 1.3 billion people have no electricity on a worldwide basis. In underdeveloped regions, this may be due to the high costs generally involved in the installation of a typical substation that uses equipment for performing two or more steps downs, such as from a high voltage level to a medium voltage level and eventually to a low voltage level. Disclosed embodiments do not involve medium voltage equipment since the stepdown is performed in one step from the high or extra-high voltage level to the low voltage level. It will be appreciated that eliminating the medium voltage equipment not only reduces the costs of the installation but is further conducive to reducing electrical losses, and thus making our disclosed embodiments relatively more energy efficient and with increased reliability.

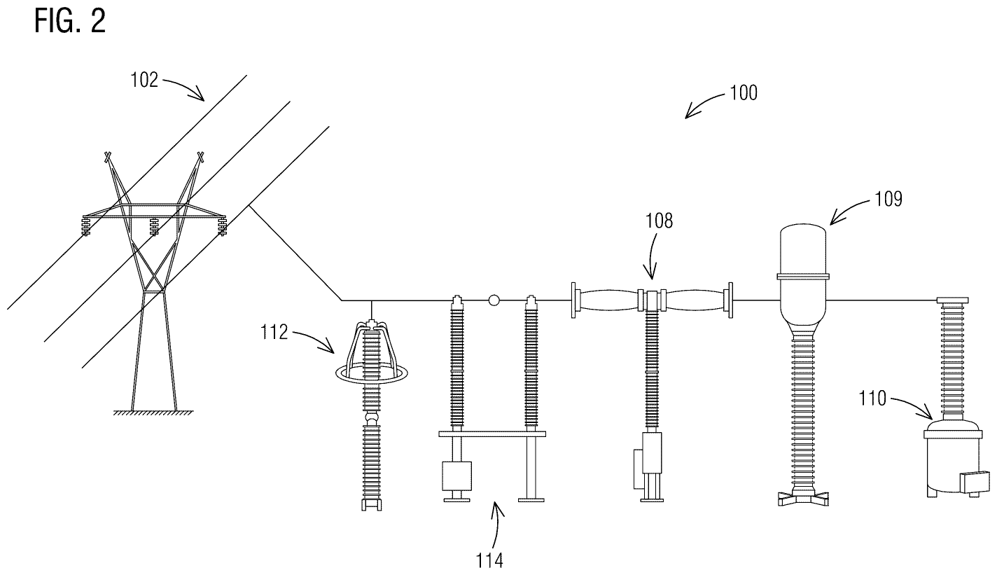

FIG. 2 is a schematic of a further embodiment of a disclosed substation 100. In this embodiment circuit device 108 is a circuit breaker. In this embodiment, a current transformer 109 is electrically connected to an output of circuit breaker 108. In operation, the circuit breaker is configured to interrupt a flow of current in response to current transformer 109 sensing a current flow indicative of the faulty condition. FIG. 2 further shows certain standard ancillary equipment that may be used in connection with disclosed embodiments, such as a lighting arrestor 112 and a disconnect switch 114, as may be used during servicing or maintenance operations in connection with the substation.

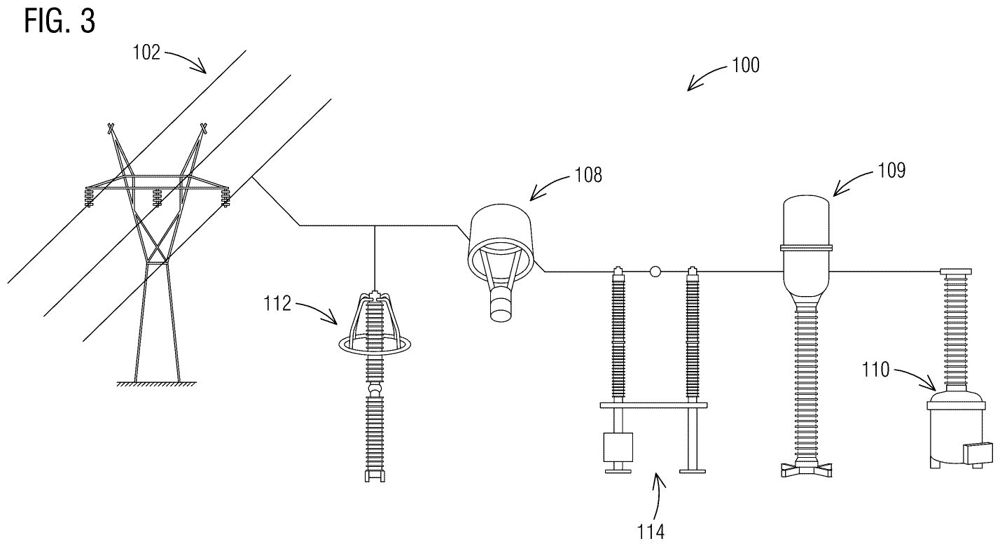

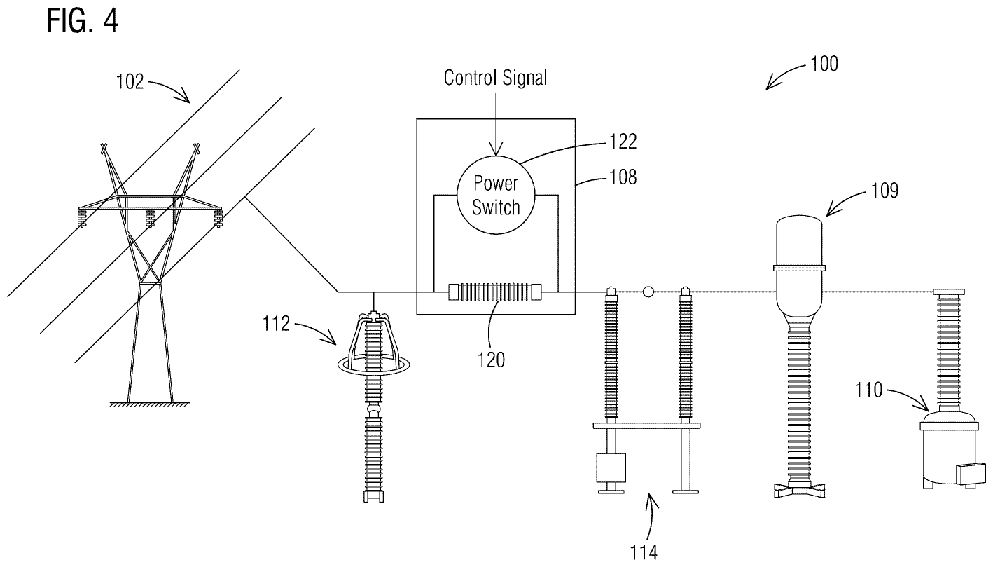

In certain embodiments, as discussed below in the context of FIGS. 3 and 4, circuit device 108 may be a device configured to limit a flow of current indicative of the faulty condition. FIG. 3 is a schematic of another embodiment of a disclosed substation 100 where circuit device 108 is embodied as a current limiting reactor.

FIG. 4 is a schematic of still another embodiment of a disclosed substation 100 where circuit device 108 is embodied as a current limiting resistive device. In one example embodiment, current limiting resistive device 108 may comprise two branches connected in parallel circuit, where one of the branches includes a power switch 122, such as an Insulated Gate Bipolar Transistor (IGBT), which is normally closed during normal operation of the substation. The second of the branches includes a resistor 120, where in the event of an electrical faulty condition, a control signal would set the power switch 122 to an electrical open condition and the magnitude of current flow during the faulty condition would be inhibited by resistor 120.

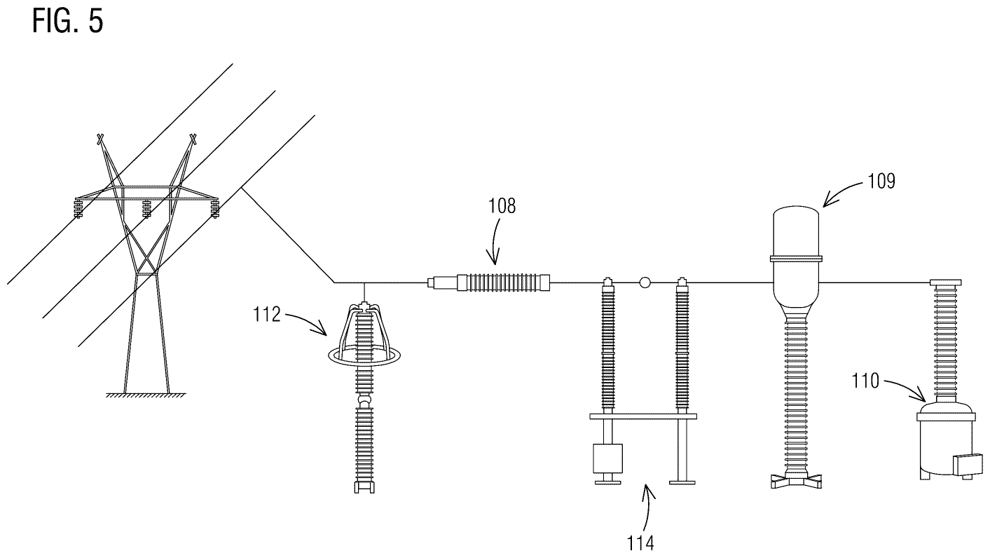

FIG. 5 is a schematic of yet another embodiment of a disclosed substation 100, where circuit device 108 is embodied as a sacrificial circuit device configured to interrupt a flow of current through power voltage transformer 110 upon occurrence of the faulty condition. One example of this type of circuit device is a fuse.

It will be appreciated that disclosed embodiments may optionally comprise an air insulated substation (AIS), where, for example, components subject to high voltage potential may be insulated from the ground by air using suitable insulating devices, such as porcelain or composite insulators and/or bushings. Alternatively, disclosed embodiments may optionally comprise a gas insulated substation (GIS) where, for example, respective components subject to high voltage potential may be located within a respective pipe, e.g., an aluminum alloy pipe, affixed to the interior of the pipe by suitable insulators, and the pipe may be filled with an appropriate insulating gas, such as nitrogen, carbon dioxide or a mixture of such gases or similar. Since a GIS substation generally involves substantially less space than an AIS substation, (in some cases, the GIS substation may occupy, for example, up to 90 percent less space compared to the AIS substation), it will be appreciated that developers and planners can have relatively greater deployment flexibility when employing GIS technology. For example, the GIS substation due to its relatively compact footprint may be housed in a portable or mobile container.

In one example embodiment, a system of substations (as described above in the context of FIG. 1 through FIG. 5), may form a modular arrangement of individual substations. The modular arrangement of individual substations is selectively interconnectable to form a scalable power generating system. For example, the modular arrangement may be formed interconnecting equipment in two containers or more depending on the needs of a give application.

Although exemplary embodiments of the present disclosure have been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope. The scope of patented subject matter is defined only by the allowed claims. Moreover, none of these claims are intended to invoke a means plus function claim construction unless the exact words “means for” are followed by a participle.

In operation, disclosed substations feature a circuit device 108 responsive to electrical faulty conditions that can arise during operation of the substation.

Examples of electrical faulty conditions, without limitation, may involve electrical shorts, electrical overloads, etc., where an excessive flow of current can quickly develop. In any case, regardless of the specific electrical faulty condition, in operation, disclosed embodiments avoid or inhibit the effects of any such faulty condition over a relatively short period of time. That is, in operation, disclosed embodiments can quickly and reliably interrupt or inhibit any excessive flow of current that otherwise could result in substantial damage to equipment and avoid the possibility of any extended interruption of power to customers.

In operation, disclosed substations, for example, may be effectively used for establishing cost-effective and reliable low voltage electrical power distribution in certain remote locations, such as may involve rural or semi-rural locations.

What is claimed is:

1. A substation connected to a high or extra-high voltage transmission line, the substation comprising:
a power line having a first end electrically connected to a singular point of the transmission line, a circuit device electrically connected to a second end of the power line to receive the high or the extra-high voltage from the transmission line, the circuit device responsive to a faulty condition that can arise during operation of the substation; and
a power voltage transformer electrically connected to the circuit device, wherein the power voltage transformer is configured to supply low voltage power directly transformed from the high or the extra high voltage received by the power voltage transformer from the circuit device.

2. The substation of claim 1, wherein the circuit device is configured to inhibit effects of the faulty condition.

3. The substation of claim 1, further comprising a current transformer electrically connected to an output of the circuit device, wherein the circuit device is configured to interrupt a flow of current in response to the current transformer sensing a current flow indicative of the faulty condition.

4. The substation of claim 1, wherein the circuit device is a circuit breaker.

5. The substation of claim 3, wherein the circuit device is a circuit breaker.

6. The substation of claim 1, wherein the circuit device is a device configured to limit a flow of current indicative of the faulty condition.

7. The substation of claim 6, wherein the circuit device is a current limiting reactor.

8. The substation of claim 6, wherein the circuit device is a current limiting resistive device.

9. The substation of claim 1, wherein the circuit device is a sacrificial device configured to interrupt a flow of current through the power voltage transformer upon occurrence of the faulty condition.

10. The substation of claim 9, wherein the circuit device is a fuse.

11. The substation of claim 1, comprising an air insulated substation (AIS).

12. The substation of claim 1, comprising a gas insulated substation (GIS).

13. The substation of claim 12, wherein the gas insulated substation is housed in a portable or mobile container.

14. The substation of claim 1, wherein a high voltage side of the power voltage transformer is rated from 60 kV to 800 kV.

15. The substation of claim 14, wherein the high voltage side of the power voltage transformer is rated from 72 kV to 550 kV.

16. The substation of claim 1, wherein the low voltage power supplied by the power voltage transformer is below 1kV.

17. The substation of claim 1, wherein transformation of the high or the extra high voltage to the low power voltage is carried out without medium voltage circuitry.

18. The substation of claim 1 connectable to power an electric vehicle charging station.

19. The substation of claim 1 connectable for village electrification.

20. The substation of claim 1 connectable for establishing a low voltage electrical power distribution in a rural or semi-rural area.

21. A system of substations comprising a modular arrangement of individual substations as recited in claim 1, the modular arrangement of individual substations selectively interconnectable to form a scalable power generating system.
